(19) United States
(12) Patent Application Publication
(10) Pub. No.: US 2021/0285723 A1
(43) Pub. Date: Sep. 16, 2021

(54) PORTABLE SAND DRYING SYSTEM AND METHOD

(71) Applicant: BOWLIN ENTERPRISES, LLC, Shreveport, LA (US)

(72) Inventor: Jon BOWLIN, Shreveport, LA (US)

(21) Appl. No.: 16/813,742

(22) Filed: Mar. 10, 2020

(51) Int. Cl. F26B 17/18; F26B 25/00; B65D 88/26; B65D 88/54

(52) U.S. Cl. CPC F26B 17/18; F26B 25/001; F26B 2200/14; B65D 88/54; B65D 88/26

(57) ABSTRACT

A portable sand drying system comprising a plurality of wheeled operational units including a feed hopper, a dryer, and a screen, wherein the wheeled operational units are supported by at least two wheels while operating. One or more of the wheeled operational units include an automatic height adjuster which, when activated, automatically elevates a portion of the wheeled operational unit from a traveling height to an operating height. The plurality of wheeled operational units further includes a motor control center (MCC) to provide power and control signals to the various other wheeled operational units. Non-MCC wheeled operational units contain a pre-wired junction box, which the MCC would plug one or more cables directly into in order to provide one of power, control signals, and both power and control signals to the non-MCC wheeled operational units.

### CROSS REFERENCE TO RELATED APPLICATIONS/PRIORITY

The present invention claims priority to U.S. Provisional Patent Application No. 62/901,848 filed Sep. 19, 2019, and Patent Cooperation Treaty Patent Application PCT/US20/19392 filed Feb. 23, 2020, both of which are incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### BACKGROUND

Sand for use in oil and gas applications many times must be dried, and sorted before it can be used. Many current methods require over $50 million in capital investment and six months or longer in construction to build such a sand dryer and sorter system. Even though businesses continue to pay the tremendous expense in time and money of the current technology, a new solution has not presented itself in the current technology. Yet, there is a pressing, but seemingly irresolvable need for a sand drying system that can be erected quickly and for a fraction of the cost of current technology.

### SUMMARY

Wherefore, it is an object of the present invention to overcome one or more of the above-mentioned shortcomings and drawbacks associated with the current technology.

The disclosed invention relates to a methods and portable sand drying systems comprising a plurality of wheeled operational units including a feed hopper, a dryer; and a screen, wherein each wheeled operational unit includes at least two road worthy wheels that together support the each wheeled operational unit while being towed to site; and a hitch to tow the each wheeled operational unit. According to a further embodiment the plurality of wheeled operational units further includes a dryer dust collector positioned adjacent to the dryer. According to a further embodiment the plurality of wheeled operational units further includes a dryer waste stacker to convey dust from the dryer dust collector to a waste pile. According to a further embodiment the dryer dust collector includes a stack and a knockout box and a baghouse, wherein the stack pivots from a horizontal traveling position to a vertical operating position. According to a further embodiment the plurality of wheeled operational units further includes a screen infeed conveyor to convey dried sand from the dryer to the screen. According to a further embodiment the plurality of wheeled operational units further includes a screen infeed conveyor to convey a screen waste conveyor to convey waste sand from the screen to a waste pile. According to a further embodiment the portable sand drying systems further include one or more silos to hold screened sand. According to a further embodiment the plurality of wheeled operational units further includes a silo in-feed conveyor to convey sand from the screen toward a silo feed lifter, which vertically raises the sand above the at least one silo. According to a further embodiment the silo feed lifter is one of a silo infeed telestacker and silo infeed elevator. According to a further embodiment the plurality of wheeled operational units further includes a silo out-feed conveyor to convey sand from the at least one silo. According to a further embodiment the plurality of wheeled operational units further includes a truck loadout conveyor to convey sand from the silo out-feed conveyor toward a truck. According to a further embodiment the one or more silos pivot from a horizontal traveling position to a vertical operating position. According to a further embodiment there are four silos, and further comprising a silo feed splitter to split feed from the silo in-feed conveyor between the four silos. According to a further embodiment one or more of the wheeled operational units include an automatic height adjuster which, when activated, automatically elevates a portion of the wheeled operational unit from a traveling height to a pre-set operational height. According to a further embodiment the plurality of wheeled operational units further includes a motor control center (MCC) to provide power and control signals to the various other wheeled operational units. According to a further embodiment non-MCC wheeled operational units contain pre-wired junction box, which the MCC would plug one or more cables directly into in order to provide one of power, control signals, and both power and control signals to the non-MCC wheeled operational units. According to a further embodiment the portable sand drying system further comprises a plurality of wooden pads placed underneath the wheels. According to a further embodiment the portable sand drying system further comprises a temperature sensor located between an exit on the dryer and an entrance on the screen; and a two-way diverter located between the temperature sensor and the entrance to the screen to divert sand that measures a temperature over a set temperature limit away from the screen. According to a further embodiment the portable sand drying system of further comprises a moisture meter located between an exit on the dryer and an entrance on the screen; and two-way diverter located between the moisture meter and the entrance to the screen to divert sand that measures a moisture over a set moisture limit away from the screen.

The disclosed invention further relates to methods and portable sand drying systems comprising a plurality of wheeled operational units including a feed hopper, a dryer, a screen, a dryer dust collector positioned adjacent to the dryer, a dryer waste stacker to convey dust from the dryer dust collector to a waste pile, the dryer dust collector including a stack, a knockout box, and a baghouse, wherein the stack pivots from a horizontal traveling position to a vertical operating position, a screen infeed conveyor to convey dried sand from the dryer to the screen, a temperature sensor located between an exit on the dryer and an entrance on the screen, a moisture meter located between an exit on the dryer and an entrance on the screen, two-way diverter located along a sand flow downstream from both the temperature sensor and the moisture meter and upstream from the entrance to the screen, the two-way diverter able to divert sand away from the screen that measures a temperature over a set temperature limit or that measures a moisture over a set moisture limit, a screen waste conveyor to convey waste sand from the screen to a waste pile, a silo in-feed conveyor to convey sand from the screen toward a silo feed lifter, the silo feed lifter is one of a silo infeed telestacker and silo infeed elevator, a silo feed splitter to split feed from the silo in-feed elevator conveyor between four silos, a first silo out-feed conveyor to convey sand from a first and second silo, a second silo out-feed conveyor to convey sand from a third and fourth silo, a truck loadout conveyor to receive sand from both the first and the second silo out-feed conveyors and to convey the sand toward a truck, a plurality of pads placed underneath the wheels, a motor control center (MCC) to provide power and control signals to the various other wheeled operational units, and a pre-wired junction box installed on non-MCC wheeled operational units, which the MCC plugs one or more cables directly into in order to provide one of power, control signals, and both power and control signals to the separate non-MCC wheeled operational units, wherein the each wheeled operational unit includes at least two road worthy wheels that support the each wheeled operational unit while being towed on a roadway to site and further comprise a trailer hitch, and wherein one or more of the wheeled operational units include an automatic height adjuster which, when activated, automatically elevates a portion of the wheeled operational unit from a traveling height to an operating height.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 is a plan view of a first embodiment of the disclosed portable sand drying system with a silo infeed telestacker;

FIG. 2 is a plan view of a second embodiment of the disclosed portable sand drying system with a silo infeed elevator;

FIGS. 3A and 3B are first and second partial elevation views of the portable sand drying system of FIG. 1;

FIGS. 4 and 5 are first and second partial elevation views of the portable sand drying system of FIG. 2;

FIG. 6A and 6B are third and fourth partial elevation views of the portable sand drying system of FIGS. 1 and 2;

FIG. 7 is a partial process flow diagram of portable sand drying system of FIGS. 1 and 2;

FIGS. 8A and 8B are respective elevation and plan views of the feed hopper shown in the portable sand drying system of FIGS. 1 and 2;

FIGS. 9A and 9B are respective elevation and plan views of the dryer shown in the portable sand drying system of FIGS. 1 and 2;

FIGS. 10A and 10B are respective elevation and plan views of the dryer dust collector shown in the portable sand drying system of FIGS. 1 and 2;

FIGS. 11 and 12 are respective elevation and plan views of the screen shown in the portable sand drying system of FIGS. 1 and 2;

FIGS. 13A and 13B are respective elevation and plan views of one of the silos shown in the portable sand drying system of FIGS. 1 and 2;

FIGS. 14A and 14B are respective elevation and plan views of the screen infeed conveyor shown in the portable sand drying system of FIGS. 1 and 2;

FIGS. 15A and 15B are respective elevation and plan views of the both the dryer waste stacker and screen waste stacker shown in the portable sand drying system of FIGS. 1 and 2;

FIGS. 16A and 16B are respective elevation and plan views of the silo infeed conveyor shown in the portable sand drying system of FIGS. 1 and 2;

FIGS. 17A and 17B are respective elevation and plan views of the silo infeed telestacker shown in the portable sand drying system of FIG. 1;

FIG. 18 is a plan view of the silo infeed elevator shown in the portable sand drying system of FIGS. 2;

FIGS. 19A and 19B are respective elevation and plan views of the first and second silo outfeed conveyors shown in the portable sand drying system of FIGS. 1 and 2;

FIGS. 20A and 20B are respective elevation and plan views of the truck loadout conveyor shown in the portable sand drying system of FIGS. 1 and 2; and

FIGS. 21-26 are additional embodiments of the disclosed portable sand drying system.

### DETAILED DESCRIPTION

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. The embodiments set forth the below represent the necessary information to enable those skilled in the art to practice the invention and illustrate the best mode of practicing the invention. In addition, the invention does not require that all the advantageous features and all the advantages need to be incorporated into every embodiment of the invention.

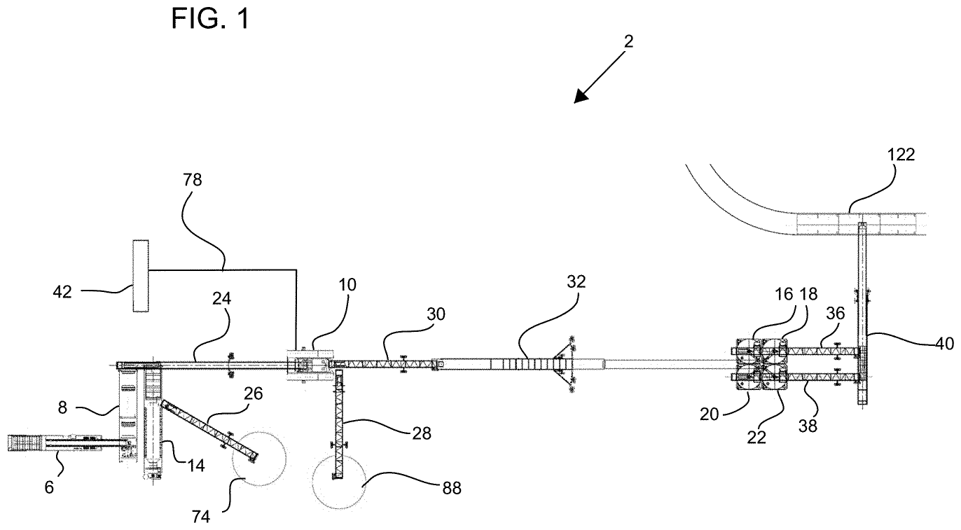

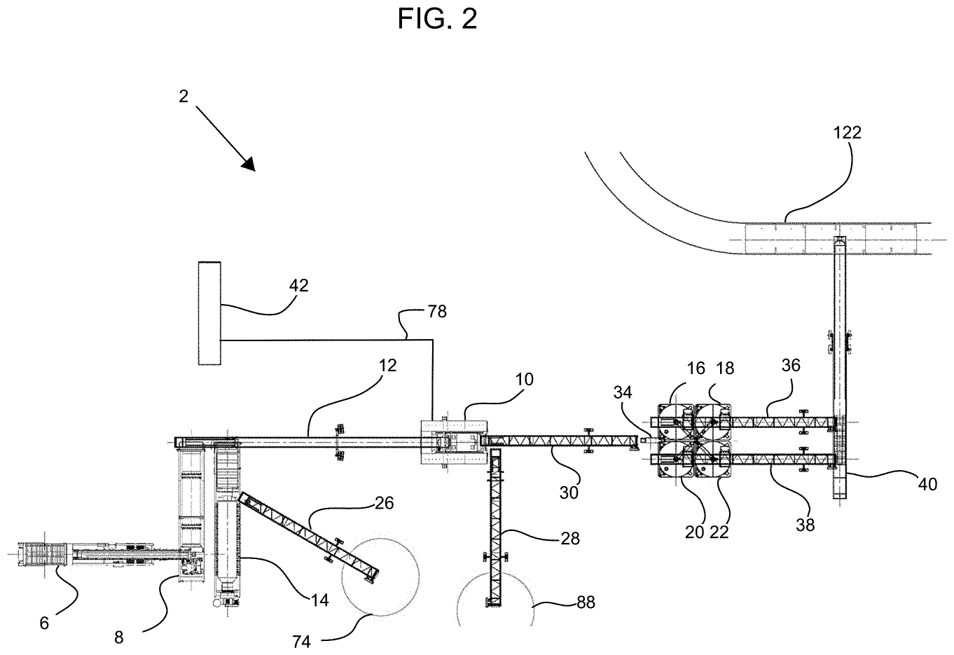

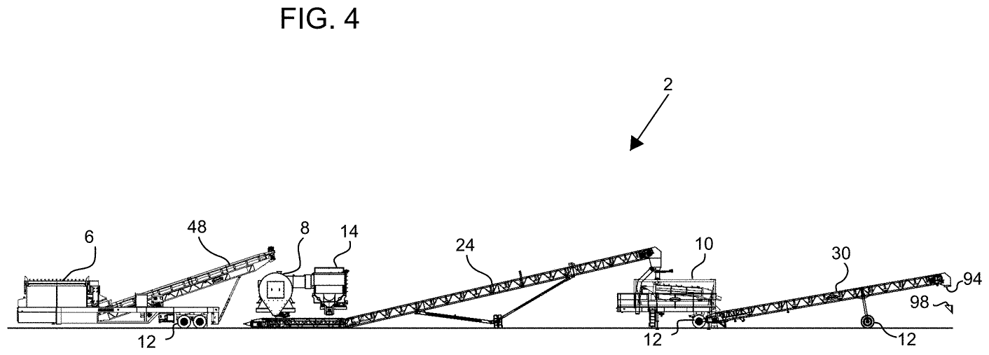

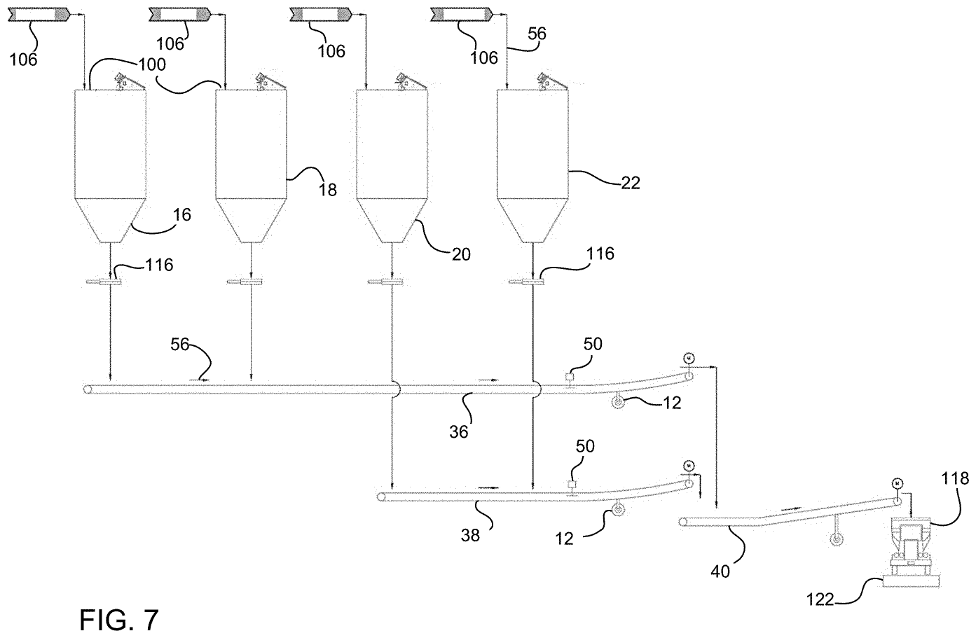

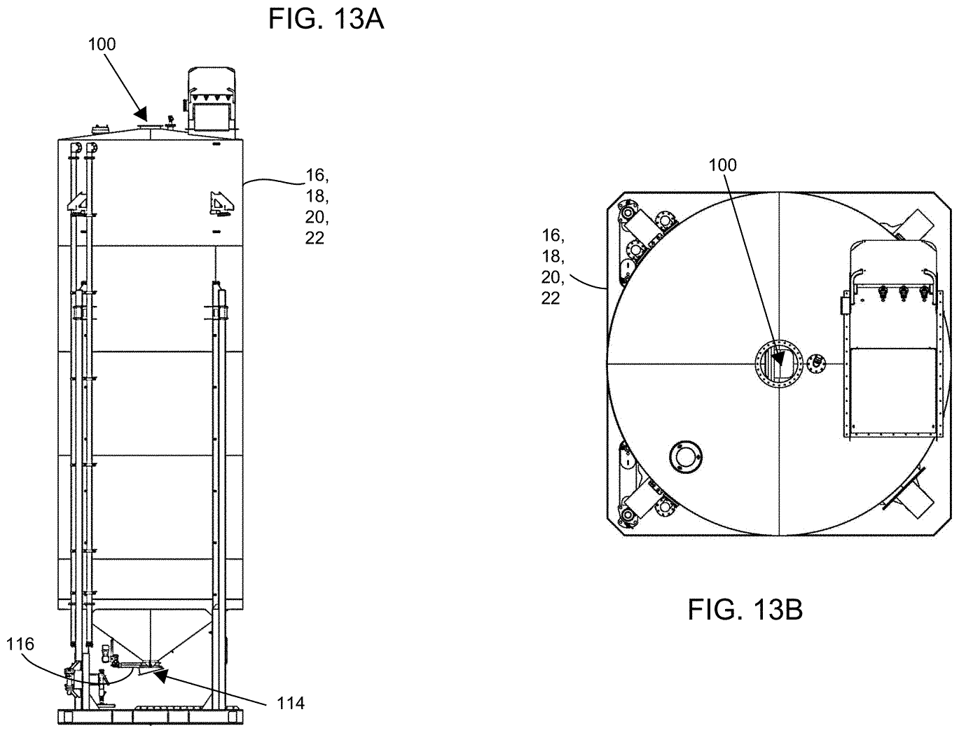

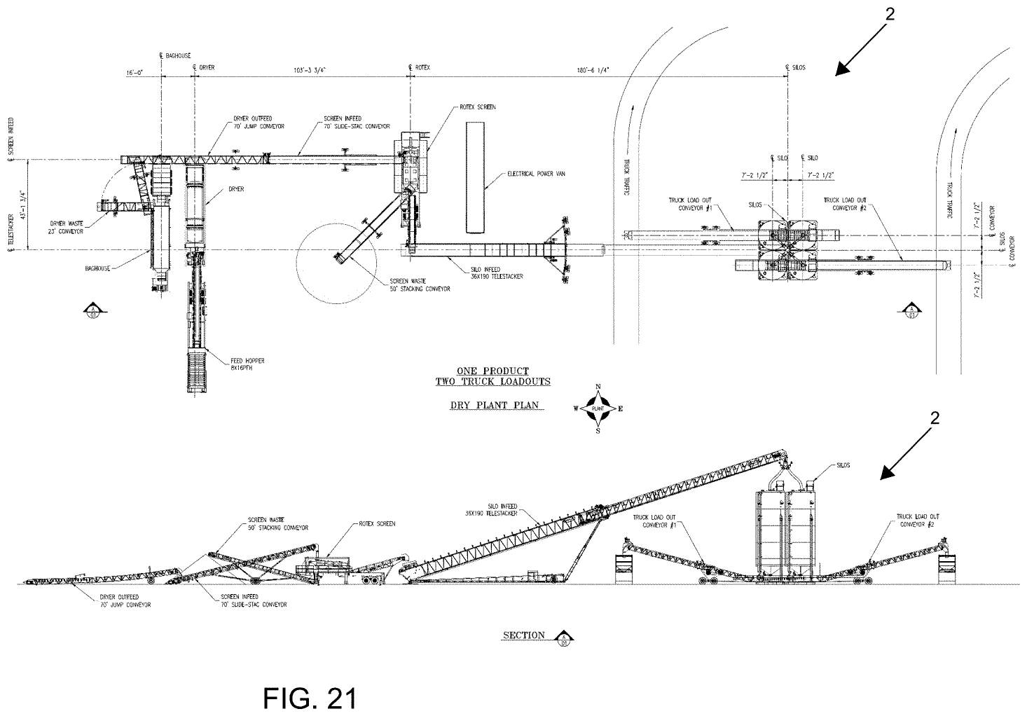

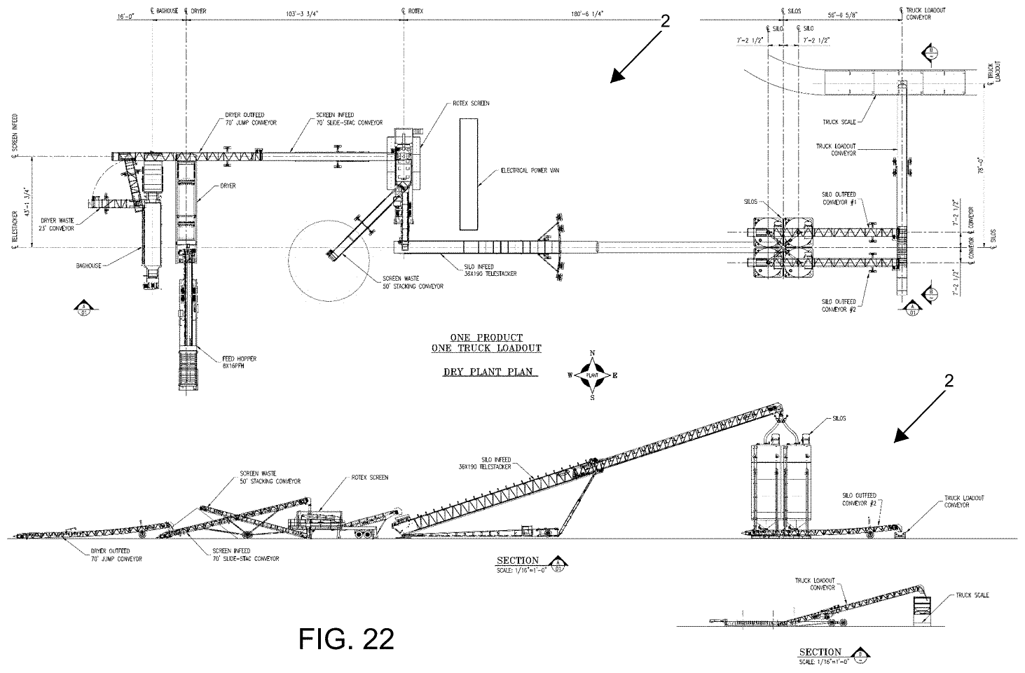

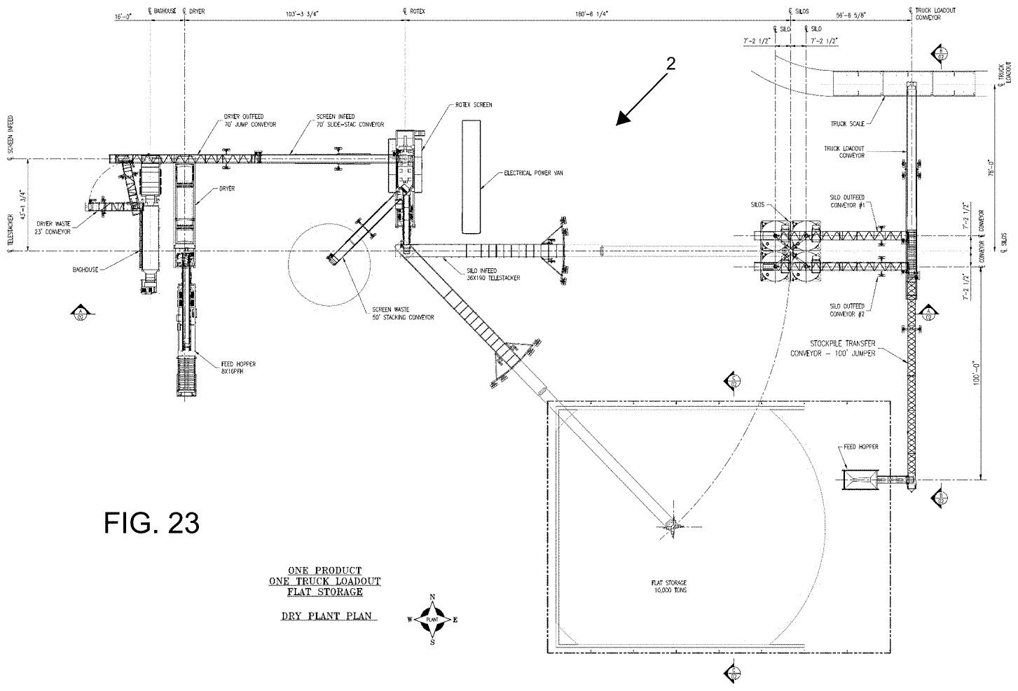

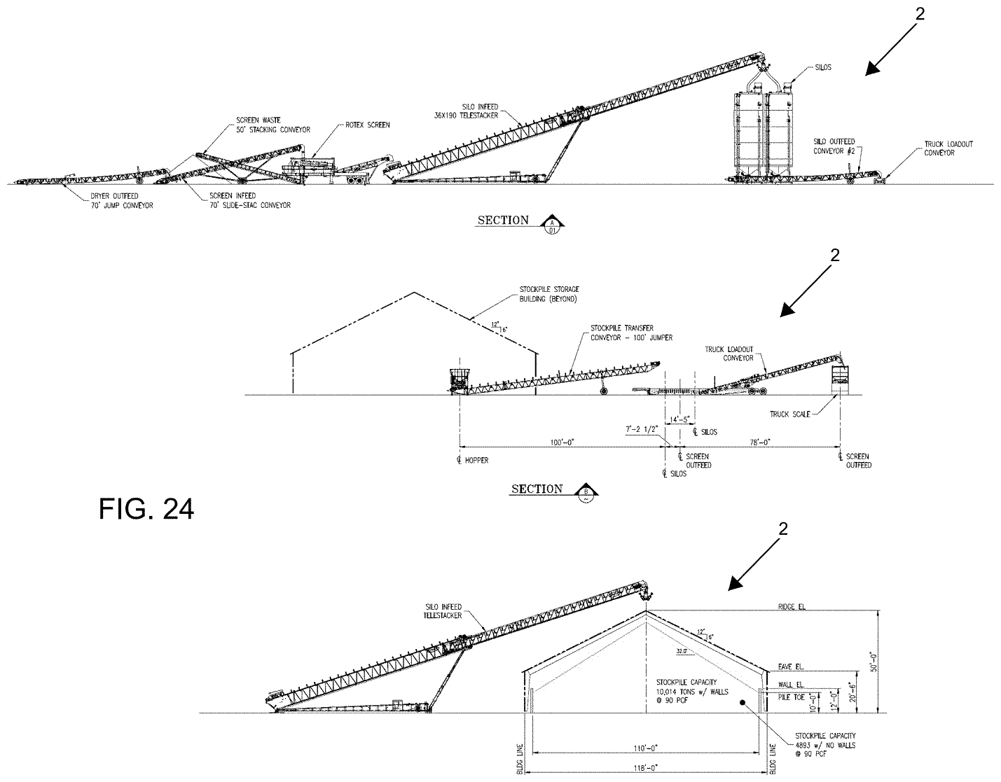

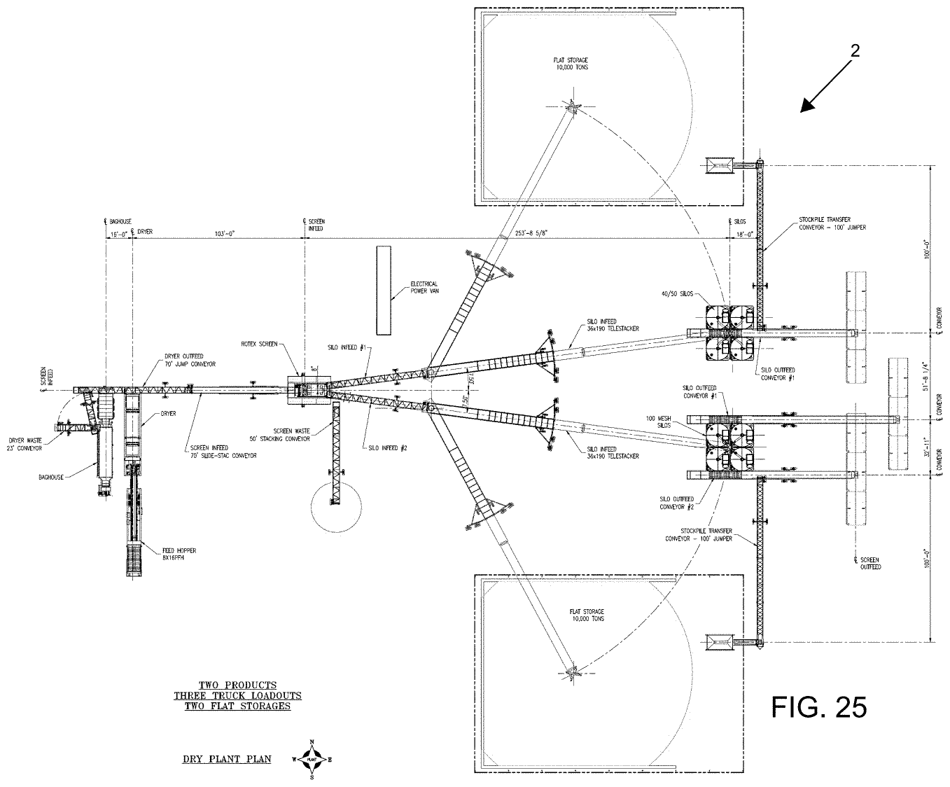

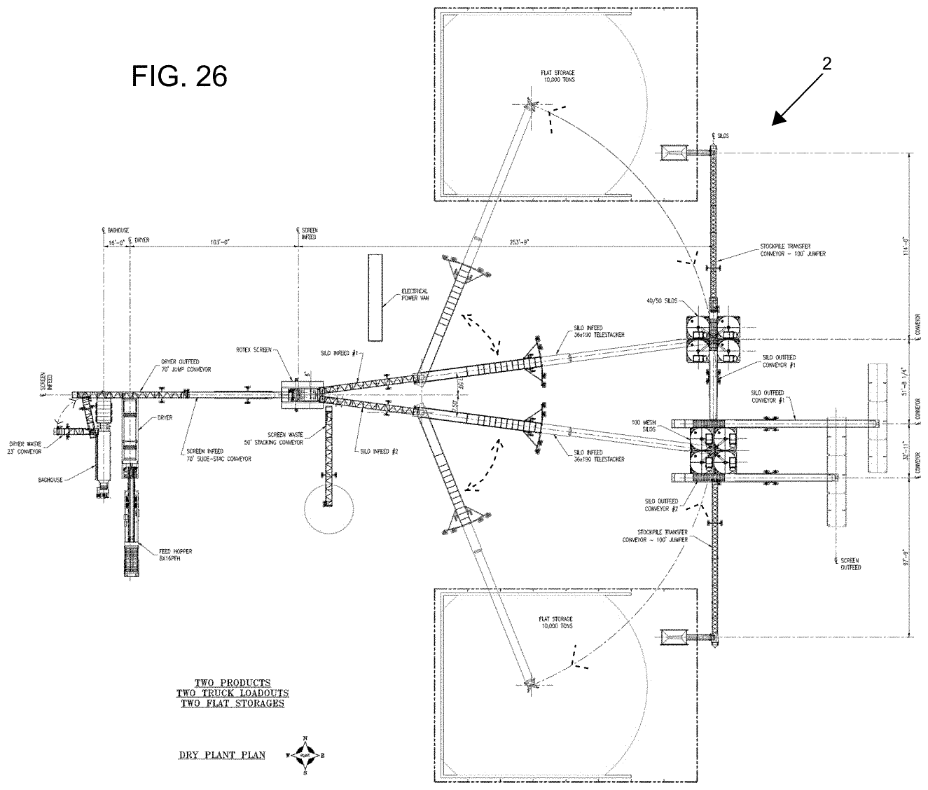

Turning now to FIGS. 1 to 26, a brief description concerning the various components of the present invention will now be briefly discussed. As can be seen in the embodiment of FIGS. 1 and 2, the portable sand drying system 2 comprises a plurality of wheeled operational units 4 including a feed hopper 6, a dryer 8, and a screen 10, wherein the wheeled operational units 4 are supported by at least two wheels 12 while operating. Additional units shown are a dryer dust collector 14, first, second, third, and fourth silos 16, 18, 20, 22, a screen infeed conveyor 24, a dryer waste stacker 26, a screen waste stacker 28, a silo infeed conveyor 30, a silo infeed telestacker 32, a silo infeed elevator 34, first and second silo outfeed conveyors 36, 38, a truck loadout conveyor 40, and a power trailer 42. The wheeled operational units 4 preferably also have a hitch 43, for attaching to a tractor trailer or other motorized vehicle to transport the wheeled operational units 4 from site to site. The various units and their interaction in the sand drying system and method will be discussed further below.

The portable sand drying system 2 in FIGS. 1 and 2 processes and output 100 tons of sand per hour, allowing permit by rule limit. Current technology takes six months to on-site build a plant of comparable processing size. The disclosed portable sand drying system 2 can take around one week or less to assemble and begin operation, once all the components are on the site. The disclosed portable sand drying system 2 significantly reduces total cost, reduces time delay costs, reduces operating cost, and reduces capital cost of processing sand for fracking and other uses.

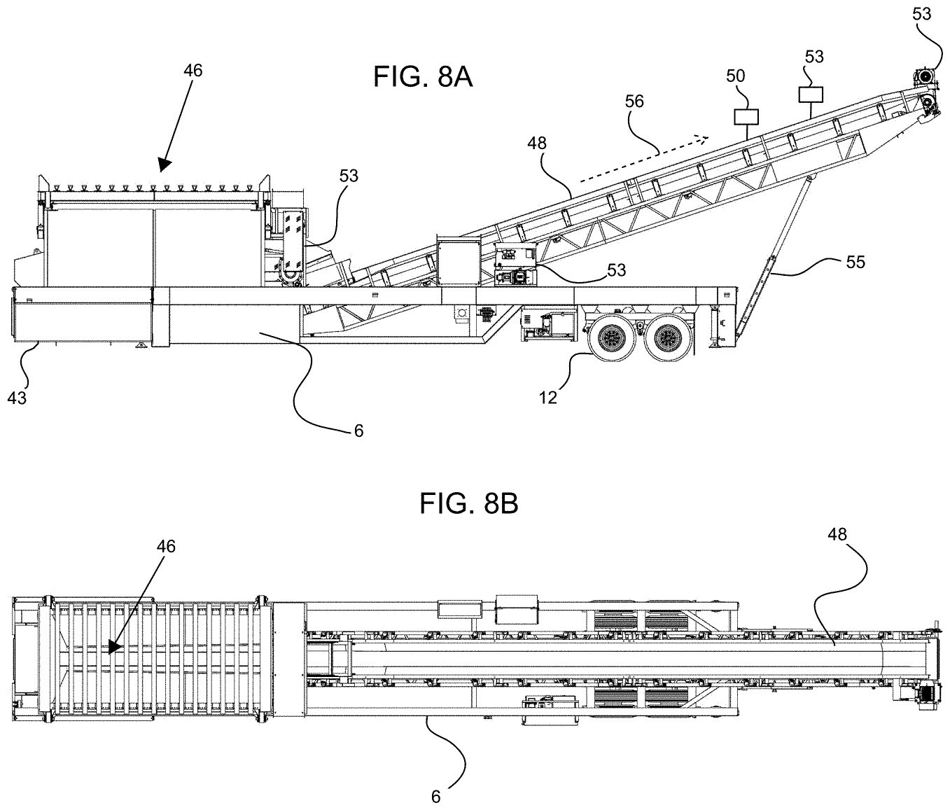

The feed hopper 6, sown in detail in FIGS. 8A and 8B, receives sand 44, normally wet, unsorted, and at ambient temperature, in to a hopper 46, and loads the sand 44 in a measured fashion from the hopper 46 onto an attached dryer infeed conveyor 48. Ahead of this process, before the feed hopper 6, is preferably a wash sort process that may be done onsite or offsite. When sand 44 is mined out of the ground, it is preferably washed to remove all organics, clays, and any minerals or anything coating the sand 44. There could be a stockpile of sand 44, that has already ben pre-cleaned, on site, and then a frontend loader can retrieve scoops of sand and dump them into the feed hopper 6. Other embodiments could have in dump trucks, bottom dumped up trucks driving over a conveyor of some sort, right to dump.

The dryer infeed conveyor 48 preferably has a belt scale 50 to measure a weight of the sand 44 and a moisture meter 52 to measure a moisture level of the sand 44. The motor 53 powered dryer infeed conveyor 48 moves the wet unsorted sand 44 over and deposits it into a dryer intake 54 of the dryer 8. The cover on this 48 and all of the other conveyors 24, 26, 28, 30, 32, 36, 38, 40 is not shown for clarity, but all conveyers 24, 26, 28, 30, 32, 36, 38, 40, 48 preferably have covers on the tops and sides and optionally bottom to prevent the rain and weather from impacting the sand 44. The conveyers 24, 26, 28, 30, 32, 36, 38, 40, 48 can have variable speed drive or variable frequency drive. The feed hopper 6 preferably also has an automatic height adjuster 55, to automatically move or pivot the dryer infeed conveyor 48 from a more horizontal traveling position to appropriately pitched operating position. One or more automatic height adjusters 55 will preferably be present on most or all of the wheeled operational units 4, to vertically align an outlet from each upstream wheeled operational unit 4 with an inlet from an adjacent downstream wheeled operational unit 4, and will be discussed in more detail below. The feed hopper has wheels 12 and a hitch 43 that are used to support and transport the wheeled operational unit from remote locations, across highways, and onto the site. Once on site, jacks/outriggers as part of the automatic height adjusters 55 will preferably lift the wheeled operational unit 4 off of its wheels and support it on 1, 2, 3, 4, or more jacks/outriggers.

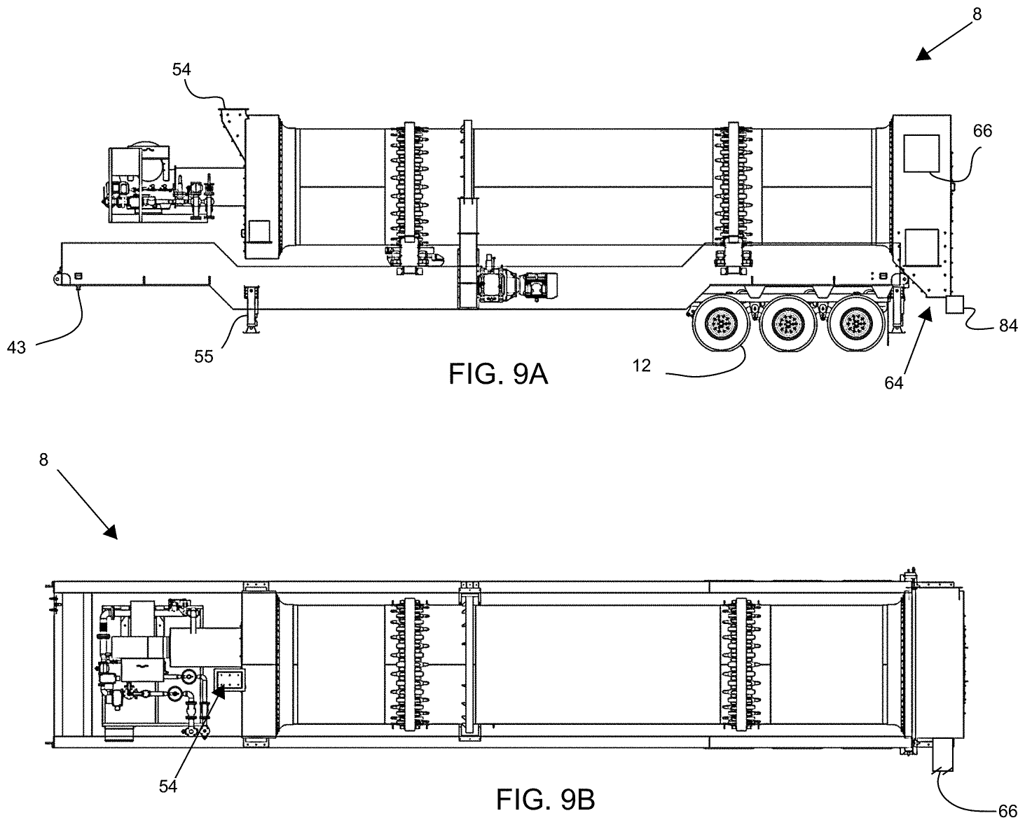

The dryer 8, shown in detail in FIGS. 9A and 9B, receive wet, unsorted, and ambient temperature sand 44 in the dryer intake 54. The dryer 8 shown is a rotary dryer 8, but other dryers, such as fluid bed for example, may be used. The dryer 8 will input a measure from a moisture meter 52 sensor, which may state the moisture level is at 10%, for example, and will input mass/weight measurement from the belt scale 50, which tells what the rate is along the flow 56 of sand 44, and a processor (not shown) computes what rate of sand is preferable for drying. For example, the dryer 8 may require the dryer infeed conveyor 48 to reduced its capacity because the sand 44 moisture content is too high. This will cause the feed hopper 6 variable speed driver or variable frequency drive to reduce speed/frequency, which can reduce the amount of sand 44 going from the hopper 46 onto the dryer infeed conveyor 48. That is one way that the portable sand drying system 2 can function to control the amount of sand 44 imputed into the dryer intake 54. The feed hopper 6 can read the moisture, as the material 44 is loading on the dryer infeed conveyor 48, for example. Then the dryer infeed conveyor 48 can then be instructed to either speed up or slow down to feed of sand 44 to supply the correct amount of sand 44 to the dryer 8. The dryer 8 to receive wet unsorted sand 44 from the dryer infeed conveyor 48, dry the sand 44, and then to dispense dry unsorted sand 44 out of the dryer outlet 64 onto the screen infeed conveyor 24. The flow 56 of sand 44 is generally one of the paths from the feed hopper 6 towards the truck loadout conveyor 40. Because the mobile sand drying system is mobile, the dryer 8 may have a burner sized for the coldest weather that the system would likely be used at in a given country or continent, and a flow restrictor or other means may be used to reduce the heat produced by the burner when it is used in a warmer location or a location with a different altitude.

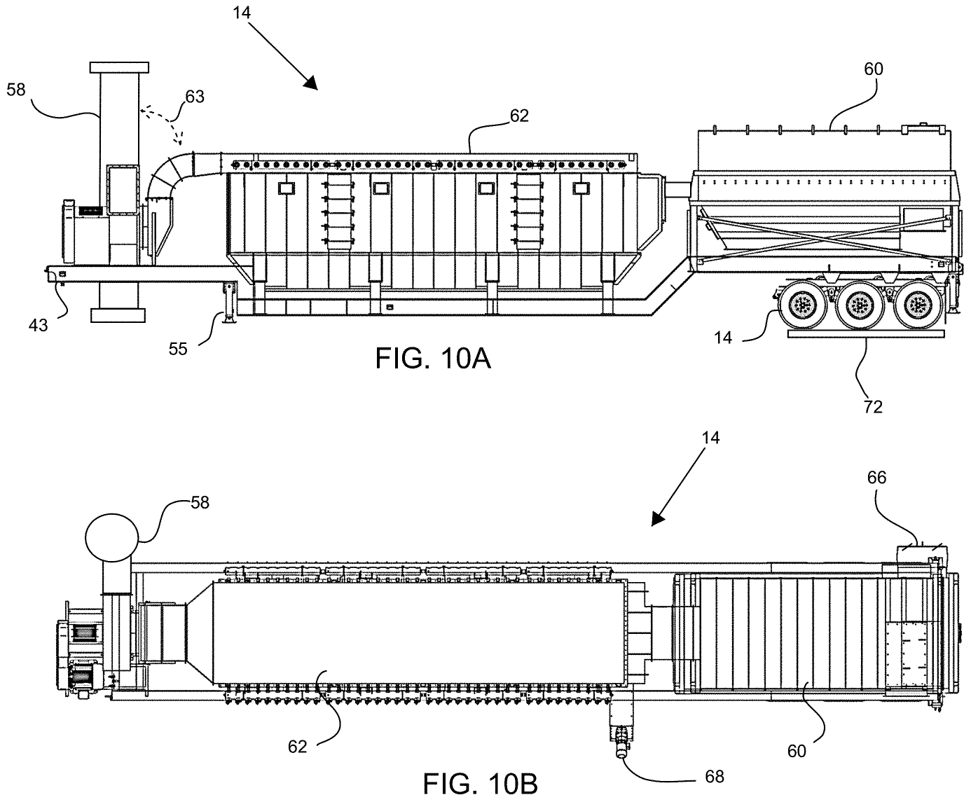

Adjacent to the dryer 8 is the dryer dust collector 14, shown in detail in FIGS. 10A and 10B. The dryer dust collector 14 includes a stack 58, a knockout box 60, and a baghouse 62. The stack 58 pivots from a horizontal traveling position to a vertical operating position along a pivot path 63, preferably with hydraulics and/or guy wires. Air enters the knockout box 60 from the dryer, and the knockout box slows the velocity of the air, allows larger particles of dust to fall from the air, and this dust can be directly conveyed to the screen infeed conveyor 30 via a knockout box outlet. Air is then routed to the bag house 62, which removes finer dust particles or the like that are produced or freed in the dryer 8 from being admitted into the atmosphere, filtering all the air coming out of the dryer 8. The filtered dust exits the dryer dust collector 14 via a dust collector outlet 68 and is preferably dropped onto a receiving location 70 of the dryer waste stacker 26. Duct work 66 connects the dryer 8 to the dryer dust collector 14 to pull positive pressure out of the dryer 8 to suck out any dust. Also shown in FIG. 10A is a pad 72 placed under the wheels 12 of the dryer dust collector 14, that is discussed in more detail below.

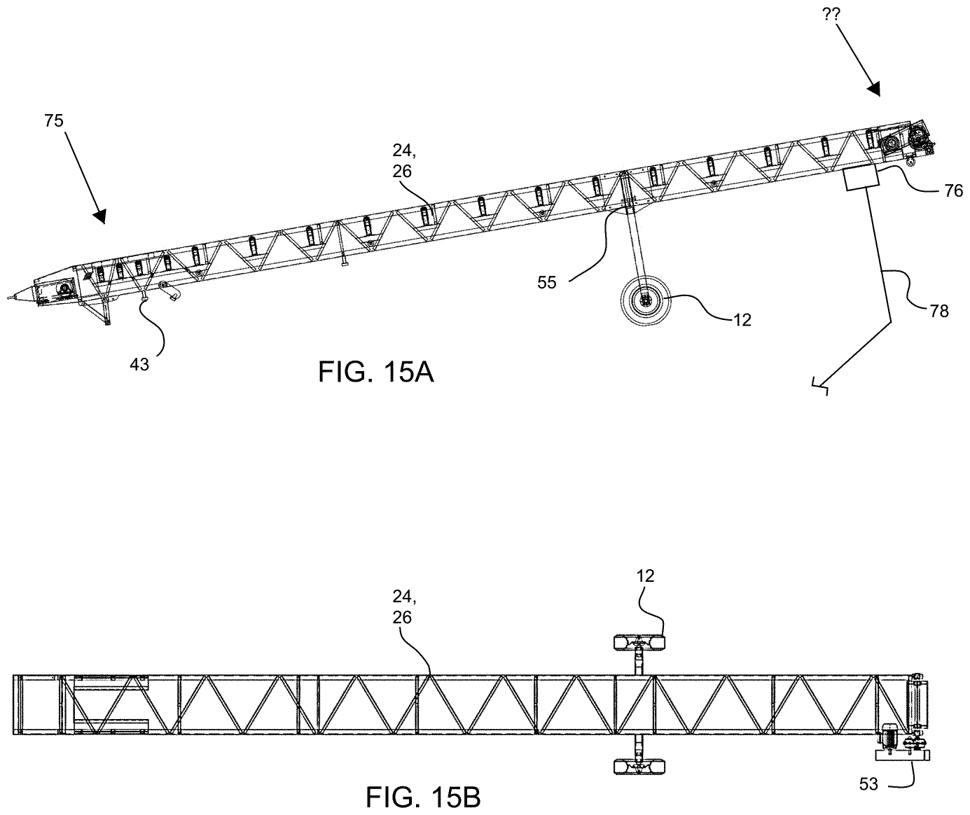

The dryer waste stacker 26, as shown in detail in FIGS. 15A and 15B, conveys dust from the dust collector outlet 68, which it receives in a loading location 73, and conveys it to either a dust waste pile 74, or to the screen infeed conveyor 30, depending on the size and type of dust, and can preferably pivot between different conveying locations. Clay particles are preferably dumped, and sand particles are preferably placed back in stream 56. The dryer waste stacker 26 is driven by a motor 53 that is preferably powered and controlled via a pre-wired junction box 76, with power and or data cables 78 connected thereto, and run to the power trailer 42, each described in more detail below. It is contemplated that the various wheeled operational units 4 may also be controlled wirelessly via a wireless transmitter and receiver, preferably located at a higher elevation on the wheeled operational unit 4, or adjacent to the pre-wired junction box 76, and/or may be automated to operate with limited outside control, via one or more sensors, a processor, a memory, and a bus located on the wheeled operational unit 4, preferably in or adjacent to the pre-wired junction box 76.

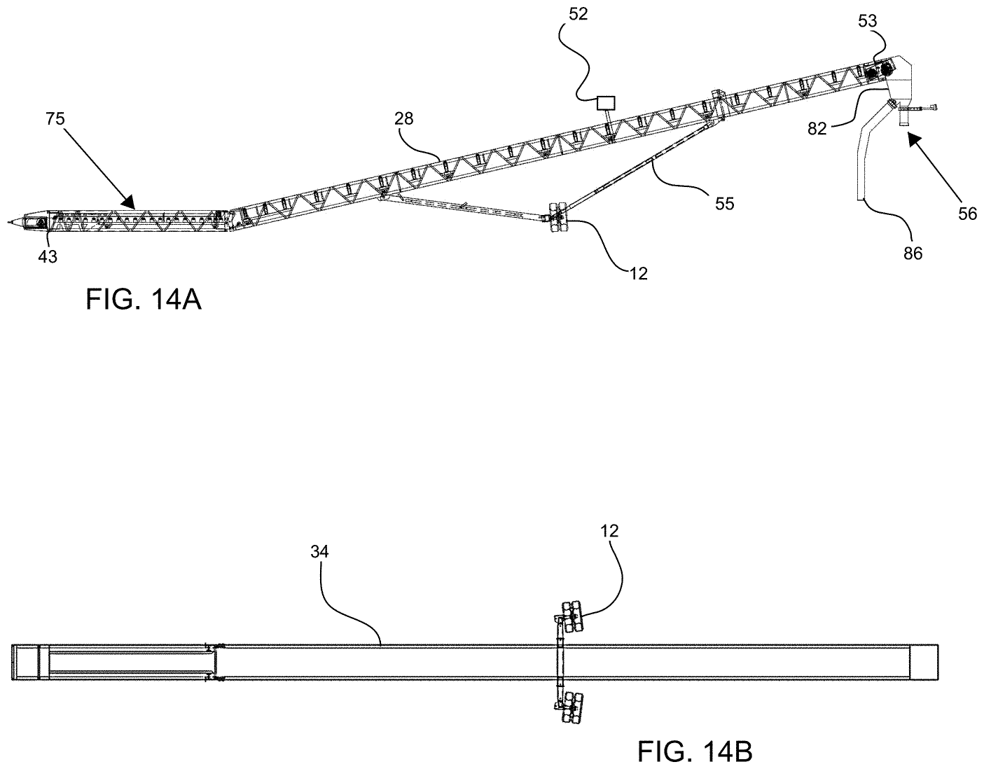

The screen infeed conveyor 30 shown in detail in FIGS. 14A and 14B, receives dried sand 44 on a loading location 75 from the dryer outlet 64, and conveys the dried sand 44 to the screen intake 80, preferably increasing elevation along the process. Positioned at terminal location of the screen infeed conveyor is a two-way diverter 82. A temperature sensor 84 is preferably located between the dryer outlet 64 and the screen intake 80. In the embodiment shown, the temperature sensor 84 is located adjacent the dryer outlet 64. A moisture meter 52 is preferably located between the dryer outlet 64 and the screen intake 80. In the embodiment show, the moisture meter 52 is located on the screen infeed conveyor 30. The two-way diverter 82 is preferably located along the sand flow 56 downstream from both the temperature sensor 84 and the moisture meter 52 and upstream from the screen intake 80. The two-way diverter 82 is able to divert sand that has over a set moisture level or over a set temperature away from the normal processing route sand flow 56 that includes the screen, instead to a waste path 86 toward a waste pile, such as the dust waste pile 74 or the screen waste pile 88 for example, by routing the diverted sand 44 to the dryer waste stacker 26 or to the screen waste stacker 28. This helps protect the screen 10 in case of malfunction in the dryer 8, for example. In the embodiment shown the two-way diverter 82 is mounted on a downstream end of the screen infeed conveyor 30, and is powered via a prewired junction box 76 on the screen infeed conveyor 30 (not shown), and preferably includes electric gates (not shown) to route material along the different paths 56, 86. In the embodiment shown, the temperature limit is less than 230 degrees F. and the moisture limit is less than 0.3% for sand moving into the screen. The limits may change based on different conditions or machine ability. In a further embodiment, temperature sensor 84 can detect temperature below a set temperature level, a condition indicative of wet sand 44, and then the two-way diverter 82 can divert such colder wet sand 44, and thereby omit using a separate moisture meter 52. The screen infeed conveyor may be in two parts, with a jump conveyor receiving material from the dryer and dryer dust collector, and then depositing it onto a slide stack conveyor, which deposits material into the screen 10. Each of the jump conveyor and slide stack conveyor being separate wheeled operational units 4.

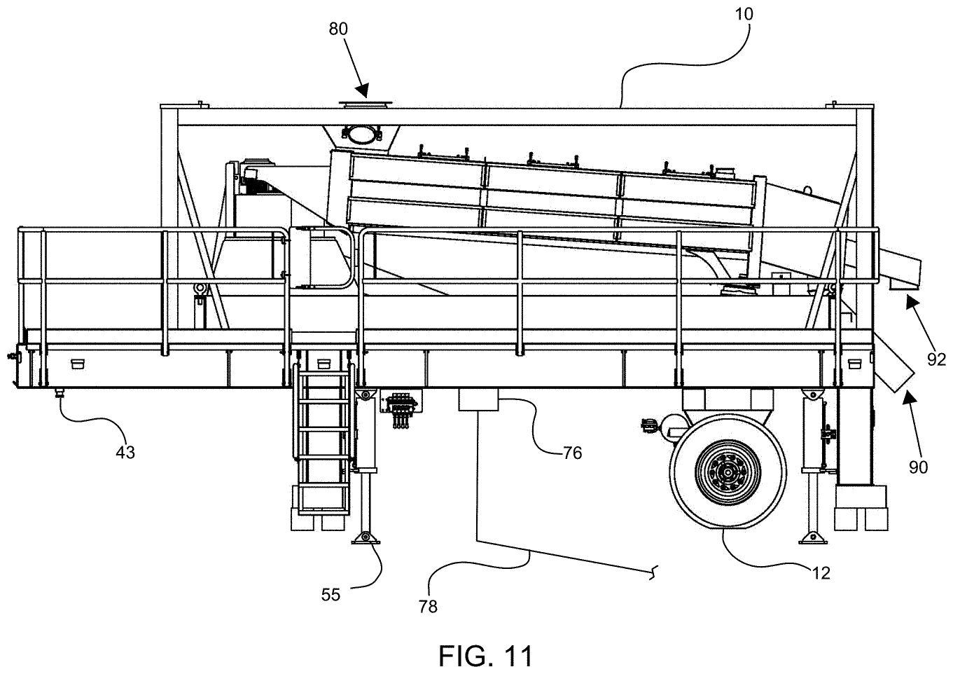

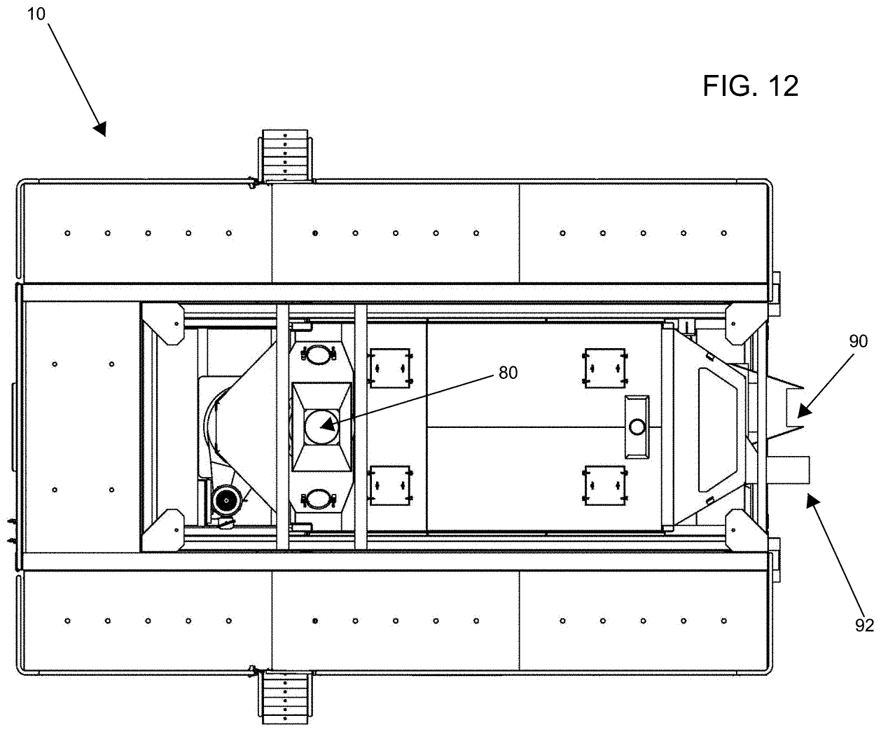

The screen 10 is shown in detail in FIGS. 11 and 12. The screen 10 is arranged to receive dry unsorted sand 44 in the screen intake 80 from the screen infeed conveyor 24, and to both output dried sorted sand 44 through the screen sand outlet 90 to the silo infeed conveyor 30, and output waste through the screen waste outlet 92 to the screen waste stacker 28. Some embodiments also include a nuisance dust collector to filter air from the screen at transfer points between conveyors. Dry sand 44 goes into the screen 10 and is separated by particle size in the machine 10.

The screen 10 shown is making a single product 44 but could alternatively make multiple products 44. In some embodiments, the screen 10 will be separating typical sand for west Texas, making a 40, 70 and a 100 mesh, or 40/140 mesh, 50/140 mesh for example. The normal size is 20/40, 40/70, and 100 mesh. Mesh is the number of holes in cloth per square inch. Once screened, any overs or waste will exit the screen 10 via the screen waste outlet 92, and be loaded onto the screen waste stacker 28 that goes out to the screen waste pile 88. The waste is what doesn't get through the 20 mesh (for example). Anything over the largest mesh, any pea gravel, anything not sand that the loader may have scooped up, the screen 10 is going to scalp that off at the top or remove that off the top. Anything that gets passed through the screen 10 in this system 2 would be product 44. Material that comes off the top of the screen 10 is considered trash. Material that passes through the top of the screen 10, would preferably be directed into the silos 16, 18, 20, 22, or boxes in other embodiments, to be shipped to the well site. The screen 10 shown is a Rotex® apex screen—Rotex® mineral separator—100 tons an hour, taking off 40 mesh. The mesh could additionally or alternatively be 20 and or 70 and or 100, for example. The screen 10 is shown suspended from frame.

The screen waste stacker 28, as shown in detail in FIGS. 15A and 15B, conveys waste from the screen waste outlet 92 to the screen waste pile 88. The screen waste stacker 28 in the embodiment shown is substantially identical to the dryer waste stacker 26.

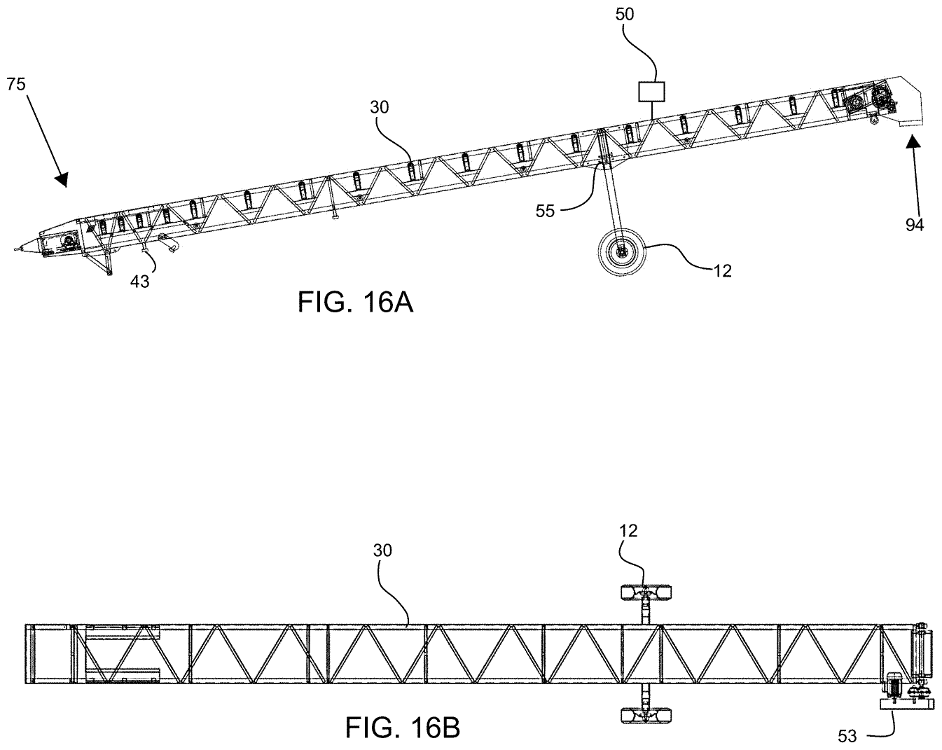

The silo in-feed conveyor 30, as shown in detail in FIGS. 16A and 16B, receives dried screened sand 44 from the screen sand outlet 90 onto a loading location 75, and conveys the sand 44 toward at the silos 16, 18, 20, 22 via a silo feed lifter 32, 34. In the embodiments shown, the silo in-feed conveyor 30 first conveys the sand 44 from a silo infeed conveyor outlet 94 to a silo feed lifter in the form of one of an telestacker intake 96 for a silo infeed telestacker 32 in the first embodiment shown in FIG. 1, and an elevator intake 98 for a silo infeed elevator 34 in the second embodiment shown in FIG. 2, each where the sand will be lifted and distributed to silos 16, 18, 20, 22, boxes, or trucks. Other silo feed lifters, in addition or in place of the silo infeed telestacker 32 and the silo infeed elevator 34 may also be utilized.

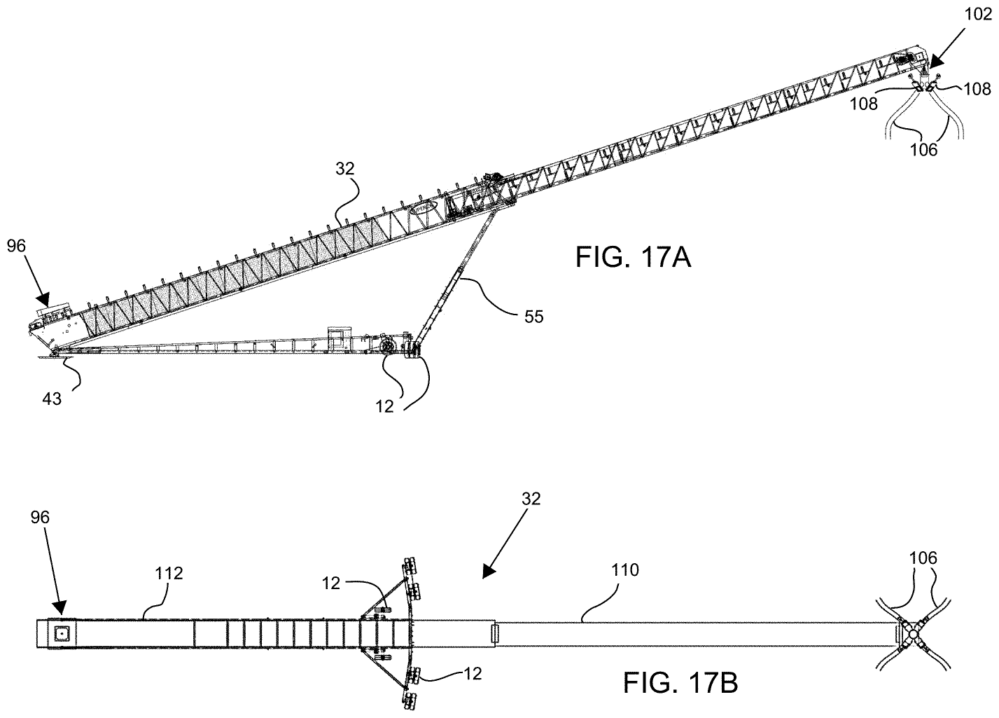

The silo infeed telestacker 32, shown in detail in FIGS. 17A and 17B, receives dry screened sand 44 from the silo infeed conveyor outlet 94 to the telestacker intake 96, and conveys the sand 44 laterally and horizontally to raise the sand to a position above the silo intakes 100 for the various silos 16, 18, 20, 22. A silo feed splitter 102 is preferably placed in the sand flow 56 path at the telestacker outlet 104. The silo infeed telestacker 32 is transported from one location to another in a retracted traveling orientation, with a telescoping section 110 retracted within a static section 112, and the unit in a substantially horizontal alignment. Once on sight, and powered, the automatic height adjuster extends the telescoping section out of the static section, and elevates the telestacker outlet 104 portion of the unit until an operating position is obtained.

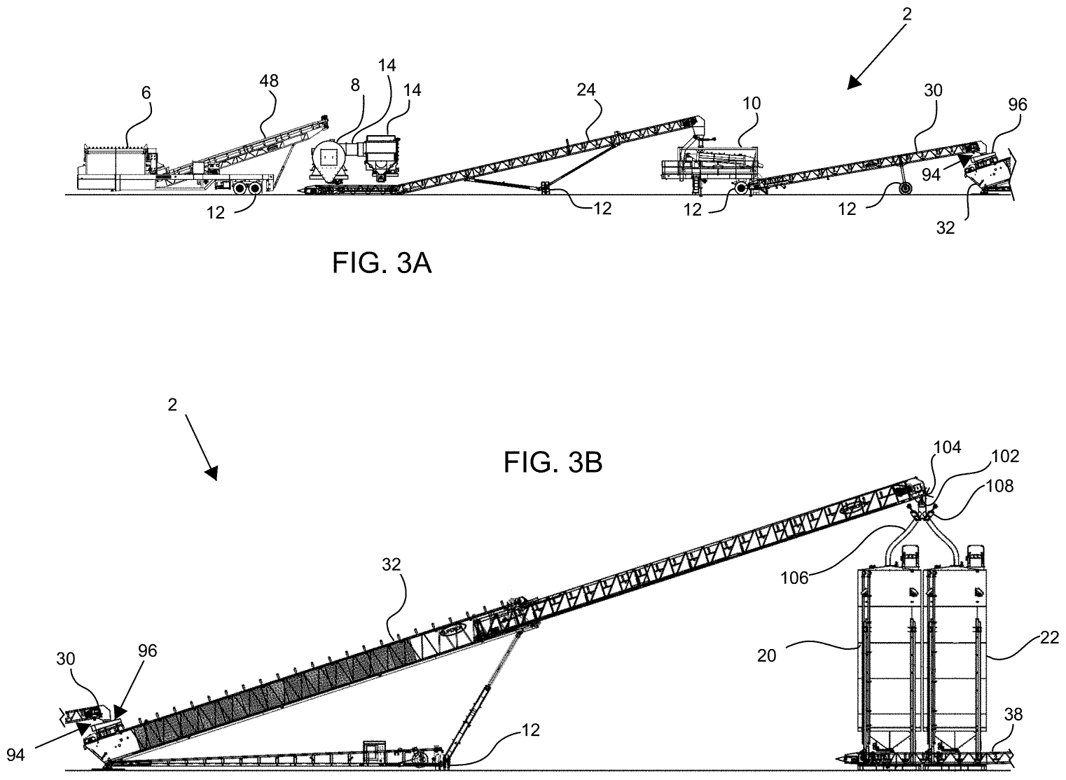

The silo feed splitter 102, shown in detail in FIGS. 3B, 5, 17A, 17B, 18, has a plurality of arms 106 to split feed from the silo infeed telestacker 32 or silo in-feed elevator 34 between the four silos 16, 18, 20, 22. Each arm 106 preferably has an electric slide gate or other such arm gate 108, such as a knife valve, to selectively allow passage of sand down one or more of the arms 106 as desired for selectively filling one or more of the silos 16, 18, 20, 22. The arm gates 108 are preferably powered via the prewired junction box on either the silo infeed telestacker 32 or silo in-feed elevator 34. In one embodiment, a portion of the feed splitter is in the form of a box, with arm gates 108 on each of the four later walls, with each arm gate opening to a separate arm 106. In a further embodiment, a fifth arm gate can be located at the bottom of the box, and a fifth arm 106 can route feed to a fifth silo an adjacent warehouse for flat storage.

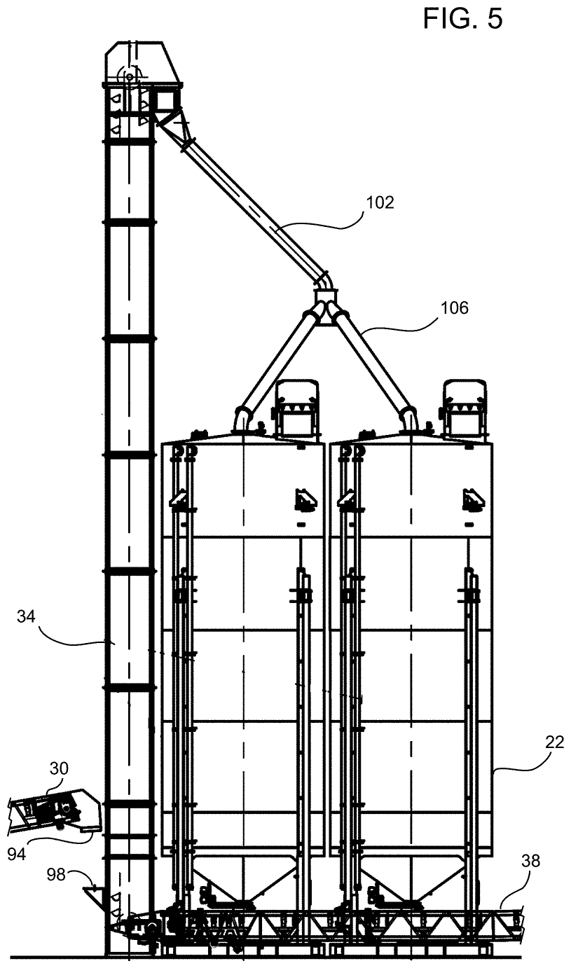

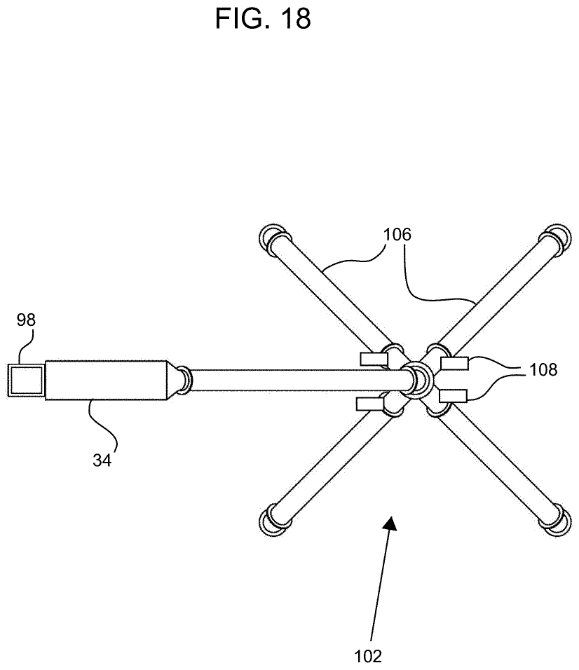

An alternative to the silo infeed telestacker 32 is a silo infeed elevator 34, as shown in detail in FIGS. 5 and 18. The silo infeed elevator 34 receives screened dry sand 44 into an elevator intake 98 from the silo in-feed conveyor 30, and vertically elevates the sand 44 to a location above the silos 16, 18, 20, 22. The silo infeed elevator 34 then conveys the sand into the silo feed splitter 102, as described above, to s selectively fill one or more of the silos 16, 18, 20, 22. The silo infeed elevator 34 shown is a bucket elevator, but other material elevators may be used. The silo infeed elevator 34 preferably has axels and wheels 12 on one end and a hitch 43 on the other (not shown), so the silo infeed elevator 34 can be trucked in and stood up, or may be a separate non-wheeled unit trucked in and stood up with hydraulics. The elevator preferably would fold in half at some point along its height, preferably around midway) to allow for more compact travel, and unfold for use on site.

The silos are shown in detail in FIGS. 3B, 5, 13A and 13B. In the embodiment shown, four silos 16, 18, 20, 22 each receive screened dry sand 44 from respective splitter arms 106 to respective silo intakes 100. The silos to hold screened sand 44, and then distribute sand through respective silo outlets 114, selectively opened and closed via electric silo outlet gates 116 positioned on each silo outlet 114, to silo outfeed conveyors 36, 38. Each silo 16, 18, 20, 22 is preferably transported in on a trailer in a horizontal orientation, are stood up to a vertical orientation as shown, and then disconnected from the trailer.

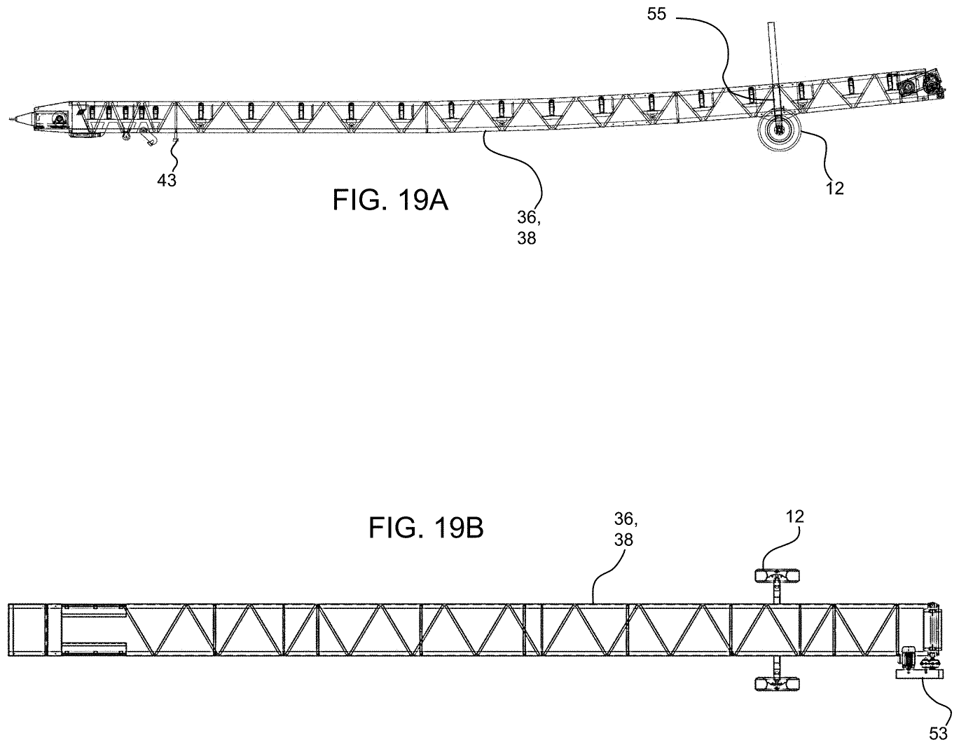

The silo out-feed conveyors 36, 38 are shown in detail in FIGS. 19A and 19B, and their respective arrangements are shown in FIGS. 1, 2, 6A, and 7. The first silo out-feed conveyor 36 is arranged under the silo outlets 114 of the first and second silos 16, 18 to receive and convey sand 44 from the first and second silos 16, 18 to the truck loadout conveyor 40, and the a second silo out-feed conveyor 38 is positioned under the silo outlets 114 of the third and fourth silos 20, 22 to receive and convey sand 44 from the third and fourth silos 20, 22 the truck loadout conveyor 40.

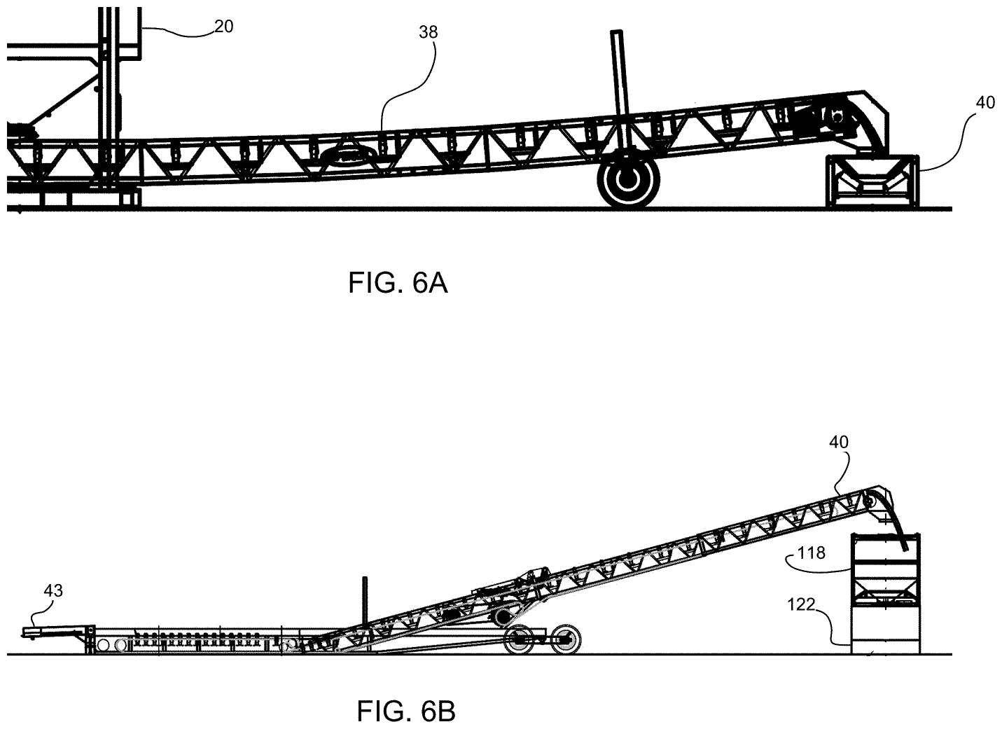

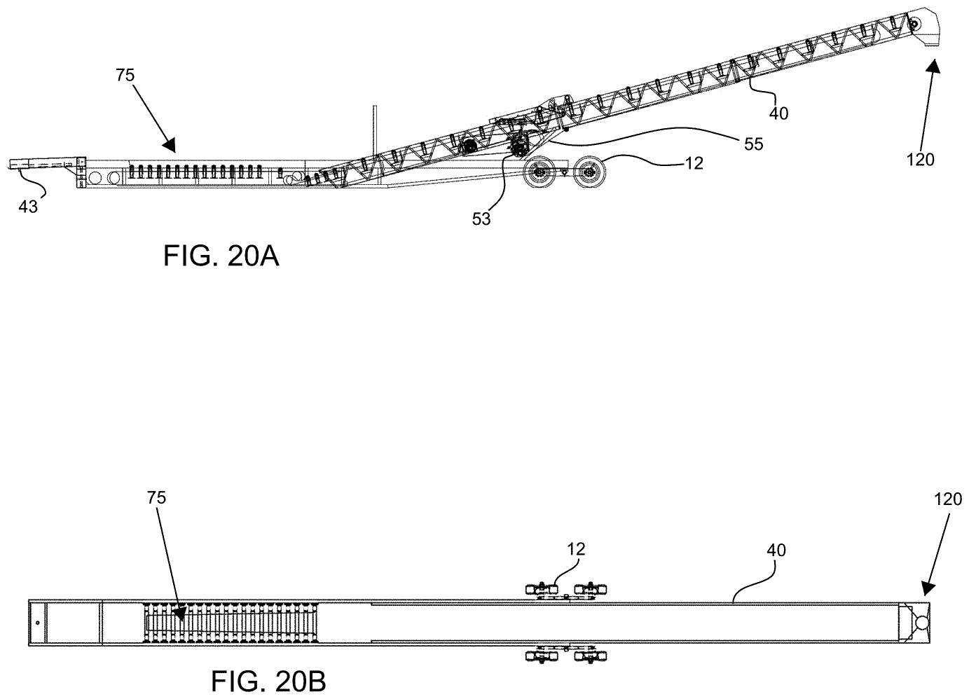

The truck loadout conveyor 40, shown in detail in FIGS. 6B, 20A and 20B, and shown in arrangement within the sand drying system in FIGS. 1, 2, and 7, for example. The truck loadout conveyor 40 is positioned below and receives screened dried sand 44 from both the first and the second silo out-feed conveyors 36, 38, and conveys the sand toward a truck 118. The truck loadout conveyor 40 preferably elevates the sand 44 as it conveys it, so that the truck loadout conveyor 40 outlet 120 can be positioned above a truck 118 for easier loading of the sand into the truck 118. A weight scale 122 is preferably positioned beneath a loading location for the truck loadout conveyor 40, so that the total amount of sand loaded into the truck 118 can be easily confirmed. A belt scale 50 may additionally or alternatively be positioned on the truck loadout conveyor 40 to measure an amount of sand loaded onto the truck 118.

As shown in FIG. 10A, one or more pads may be placed underneath the wheels 12 of the various wheeled operational units 4. In prepping for the wheeled operation units 4, a piece of equipment that has vibration or any type of movement to it, such as the screen 10 for example, could settle over time. One option is to lay a large concrete foundation, but that is very expensive. This would involve going onsite and stripping off organic and loose material. Optionally, sole stabilization and/or some base course could be put down just to level everything. Then the area could be covered with pads 72, such as wooden crane maps, also known as timber mats or heavy equipment mats. This helps prevent the machines from working down in the dirt as the equipment operates. Instead the mats, or a functional equivalent, creates a good hard base that also helps distribute the load of the equipment, and prevents the wheels or jack pads from settling down into the ground. Alternatively, the pads could be placed just beneath where the ground contacts (wheels 12, etcetera) would be for wheeled operational units 4 that have vibrations or move. The power trailer 42, for example, would likely not require a pad 72, as there would be very little motion or vibration from that wheeled operational unit 4.

The power trailer 42 is shown schematically in FIGS. 1 and 2. In the embodiment shown. In one embodiment, the power trailer 42 is in the form of a trailer mounted 40-foot shipping container, with a generator room on one end, a windowed control room on the other end, and an motor control center (MCC) in the middle, to provide power and control signals via power and control cables 78 to the various other wheeled operational units 4. Power and control cables 78 stretch from the power trailer 42 to the various conveyors 24, 26, 28, 30, 32, 40, 48 and other wheeled operation units 4. Most power cables 78 have been omitted from the drawings for clarity. Windows are preferably disposed on the walls of the control room to allow visualization of the sand drying system 2 for a human monitor. The power cables 78 will connect the power trailer 42 to the pre-wired junction boxes 76 on the other wheeled operational units 4. All the motor control centers (MCCs) for this entire sand drying system will preferably be into the MCC room pre-wired, free and ready to go. The computer system will be in the operator's room, and it will have windows so the operator can sit in there and look out over the plant. Preferably, leads will be pulled up and zip tied, and the power trailer will be parked within a distance of the various wheeled operation units 4 so that the respective cables 78 can reach the prewired junction boxes 76 on the respective wheeled operation units 4.

The pre-wired junction box 76 is shown symbolically in FIGS. 11 and 15A. The pre-wired junction boxes 76 are installed on non-MCC wheeled operational units 4, and once onsite, the MCC 42 plugs one or more cables 78 directly into the respective pre-wired junction box 76 in order to provide one of power, control signals, and both power and control signals to the separate non-MCC wheeled operational units 4. The motors on the non-MCC wheeled operational units 4 would be wired to run back to the respective pre-wired junction box 76 mounted on that non-MCC wheeled operational unit 4. The cables coming from the motor 53 would be hard wired right into the respective pre-wired junction box 76 through a cord grip, for example. Then the power cables 78 running from the pre-wired junction box 76 to the power trailer 42 could be hard wired into pre-wired junction box 76 through cord grip and then the end that connects to the power trailer 45 could use a Hubbel pin and Sleeve connector. For the various motors on the various non-MCC wheeled operational units, the pre-wired junction box 76 could include: HUBBELL® 20 AMP/RECEPTACLE—HBL420R7W/PLUG—HBL420P7W MELTRICO 200 AMP/RECEPTACLE—37-24043/PLUG—37-28043; HUBBELL® 100 AMP/RECEPTACLE—HBL4100R7W/PLUG—HBL4100P7W HUBBELL® 60 AMP/RECEPTACLE—HBL4060R7W/PLUG—HBL4060P7W. For the control side it will preferably work in a same manner, except for plugging into the power trailer will preferably use a Phoenix Contact ® HEAVYCON® type connectors. All of the wheeled operational units 4 are preferably pre-wired and pre-plumed as needed for electricity, air, water, hydraulics, pneumatics and, if desired, fuel, to one or more boxes on the respective trailers, so supply and control cables/conduits can be run to the prewired junction box 76, quickly and easily. The controls will probably be run through a cat five cable from the MCC 48.

Automatic height adjusters 55 are shown in various Figures. One or more of the wheeled operational units 4 include an automatic height adjuster 55 which, when activated, automatically elevates a portion of the wheeled operational unit 4 from a traveling height to an operating height. The wheeled operational units 4 are shown in drawings in their operating position height. In a retracted/traveling position, portions of the wheeled operational units 4 will lower, especially conveyors 24, 26, 28, 30, 32, 40, 48, to allow for a more compact wheeled operational unit 4, increased maneuverability, and greater passage for transporting the wheeled operational unit across the roadways.

Air compressor systems and optional generators in the portable sand drying system 2 not shown, including pneumatic piping and hoses. Generators are optional if the portable sand drying system 2 is located in a location with permanent power in place.

In the embodiment shown, two of the conveyors 26, 28 are substantially identical. In other embodiments more of the conveyors may be identical. In one embodiment, at least three conveyor belts are identical, in another at least four or five are identical. For the various wheeled operational units 4, there are preferably wheels toward one end, and there's a hitch on the other end that allows for the wheeled operational unit 4 to be hooked up to a pickup truck or other automobile/tractor.

The dryer 8 and dryer dust collector 14 are each shown mounted on custom built chasis and trailers. Other type trailers may be used, or axils and wheels could be mounted on the dryer 8 and dryer dust collector 14, along with a hitch 43, so that each could be mobile without a trailer.

An air compressor and a compressed air dryer (not shown) are preferably also provided. Also, if there is no power on-site, generator would preferably be provided. There is preferably an air compressor mounted adjacent to the baghouse, and another mounted with loadout by the silos. Because of the efficiency of the system, these air compressors may be small, such as just 5 hp.

The fuel source for dryer 8 is preferably a hydrocarbon, such as methane, propane, natural gas, LNG, or diesel, for example. The fuel source would be connected to the burner of the dryer 8.

Once a loader dumps wet unsorted sand 44 in the hopper 46, preferably the entire process is automated and in control of the MCC 42.

To set up system, once ground is prepared, a driver comes in and unhitches the dryer 8 that is mostly horizontal. Once set up, a button will be pushed on the dryer or automatically, jacks drop down and it will preferably have an outrigger, such as, big crane outriggers could come down. Pads 72 would then preferably be placed. The outrigger could raise the trailer up and automatically set the decline slope of the dryer 8. The outriggers being part of the dryer's 8 automatic height adjuster 55. The dryer 8 would be preferably lifted off of the wheels 12 and supported by the 2, 3, 4 or more jacks/outrigger portion of the automatic height adjuster 55. Once the dryer 8 is placed, other wheeled operational units 4 could be placed with in horizontal and vertical relation to the drier 8. In a preferred embodiment, the feed hopper 6, the dryer 8, the screen 10 and the dryer dust collector 14 would all be towed/driven into place supported at least partially by their wheels 12, and then once in place, lifted off of their wheels 12 by their automatic height adjuster 55 and supported by 2, 3, 4 or more jacks/outrigger. In other embodiments, some others or all wheeled operational units 4, once in place, will be lifted off their wheels 12 once in place and be by their automatic height adjuster and supported by jacks/outrigger.

In one embodiment the portable sand drying system can be automatically assembled, for greater accuracy and reduced man hour requirements. Using GPS technology, such as GPS receivers, memory, processors, wireless transmitters and receivers, and proximity and other sensors on each wheeled operational unit 4, and having electric motors 53 on all of the wheeled operational units 4 to power maneuver them at non-road speeds, the various wheeled operational units 4 can self-assemble. Preferably, a survey would first be done and the land on site would be sufficiently cleared as needed, with ground support added as needed. Then appropriate coordinates horizontal and vertical alignments would then be given for each wheeled operational units 4, and the wheeled operational units 4, once delivered to the site, could self-maneuver/drive to the exact location required with respect to each other and the dryer, communicating between the various wheeled operational units 4 as needed, to complete the system, and then will elevate appropriate portions from a traveling position to an operating position to vertically align the portable sand drying system 2.

No crane is required to set up the portable sand drying system 2. Preferably, a small boom truck is used for setting the ductwork between the dryer and the dryer dust collector, but the remaining units are preferably unhitched and automatic height adjusted.

Though not required, for maximum efficiency, the truck is parked on the scale during loading, the truck scale being certified for trade. The truck loadout conveyor would be run at maximum capacity for 80-90% of the load, for example, and then slower to finish the load off.

Preferably, there is also an integrated lighting system on the various wheeled operational units 4, also powered via the pre-wired junction boxes.

In a further embodiment, especially when the screen is screening for multiple sand sizes, with each feed could flowing to its own separate set of silo infeed conveyor, silo feed lifter, one or more silos, silo out feed conveyor and truck loadout conveyor and scales, though some overlap between units used and feeds may occur.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

### REFERENCE NUMBERS

2 sand drying system

4 wheeled operational units

6 feed hopper

8 dryer

10 screen

12 wheels

14 dryer dust collector

16 first silo

18 second silo

20 third silo

22 fourth silo

24 screen feed conveyor

26 dryer waste stacker

28 screen waste stacker

30 silo infeed conveyor

32 silo infeed telestacker

34 silo infeed elevator

36 first silo outfeed conveyor

38 second silo outfeed conveyor

40 truck loadout conveyor

42 power trailer

43 hitch

44 sand

46 hopper

48 dryer infeed conveyor

50 belt scale

52 moisture meter

53 motor

54 dryer intake

55 automatic height adjuster

56 sand flow

58 stack

60 knockout box

62 baghouse

63 pivot path

64 dryer outlet

66 ductwork

68 dust collector outlet

70 dryer waste stacker receiving location

72 pad

74 dust waist pile

75 loading location

76 pre-wired junction box

78 power cables

80 screen intake

82 two way diverter

84 temperature sensor

86 waste path

88 screen waste pile

90 screen sand outlet

92 screen waste outlet

94 silo infeed outlet

96 telestacker intake

98 elevator intake

100 silo intake

102 silo feed splitter

104 telestacker outlet

106 splitter arms

108 arm gates

110 telescoping section of telestacker

112 static section of telestacker

114 silo outlet

116 electric silo outlet gate

118 truck

120 outlet for truck loadout conveyor

122 scale

Wherefore, I/we claim:

1. A portable sand drying system comprising:
a plurality of wheeled operational units including
a feed hopper
a dryer; and
a screen;
wherein the wheeled operational units are supported by at least two wheels while operating.

2. The portable sand drying system of claim 1 wherein the plurality of wheeled operational units further includes a dryer dust collector positioned adjacent to the dryer.

3. The portable sand drying system of claim 2 wherein the plurality of wheeled operational units further includes a dryer waste stacker to convey dust from the dryer dust collector to one of a waste pile and a screen infeed conveyor.

4. The portable sand drying system of claim 2 wherein the dryer dust collector includes a stack and a knockout box and a baghouse, wherein the stack pivots from a horizontal traveling position to a vertical operating position.

5. The portable sand drying system of claim 1 wherein the plurality of wheeled operational units further includes a screen infeed conveyor to convey dried sand from the dryer to the screen.

6. The portable sand drying system of claim 1 wherein the plurality of wheeled operational units further includes a screen waste conveyor to convey waste sand from the screen to a waste pile.

7. The portable sand drying system of claim 1 further comprising one or more silos to hold screened sand.

8. The portable sand drying system of claim 7 wherein the plurality of wheeled operational units further includes a silo in-feed conveyor to convey sand from the screen toward a silo feed lifter, which vertically raises the sand above the at least one silo.

9. The portable sand drying system of claim 8, wherein the silo feed lifter is one of a silo infeed telestacker and silo infeed elevator.

10. The portable sand drying system of claim 7 wherein the plurality of wheeled operational units further includes a silo out-feed conveyor to convey sand from the at least one silo.

11. The portable sand drying system of claim 10 wherein the plurality of wheeled operational units further includes a truck loadout conveyor to convey sand from the silo out-feed conveyor toward a truck.

12. The portable sand drying system of claim 7 wherein the one or more silos pivot from a horizontal traveling position to a vertical operating position.

13. The portable sand drying system of claim 7 wherein there are four silos, and further comprising a silo feed splitter to split feed from the silo in-feed conveyor between the four silos.

14. The portable sand drying system of claim 1 wherein one or more of the plurality of wheeled operational units include an automatic height adjuster which, when activated, automatically elevates a portion of the wheeled operational unit from a traveling height to an operating height.

15. The portable sand drying system of claim 1 wherein the plurality of wheeled operational units further includes a motor control center (MCC) to provide power and control signals to the various other wheeled operational units.

16. The portable sand drying system of claim 1 wherein non-MCC wheeled operational units contain pre-wired junction box, which the MCC would plug one or more cables directly into in order to provide one of power, control signals, and both power and control signals to the non-MCC wheeled operational units.

17. The portable sand drying system of claim 1 further comprising a plurality of wooden pads placed underneath the wheels.

18. The portable sand drying system of claim 1 further comprising a temperature sensor located between an exit on the dryer and an entrance on the screen; and a two-way diverter located between the temperature sensor and the entrance to the screen to divert sand over a set temperature away from the screen.

19. The portable sand drying system of claim 1 further comprising a moisture meter located between an exit on the dryer and an entrance on the screen; and two-way diverter located between the moisture meter and the entrance to the screen to divert sand over a set moisture level away from the screen.

20. A portable sand drying system comprising:
a plurality of wheeled operational units including
a feed hopper
a dryer;
a screen;
a dryer dust collector positioned adjacent to the dryer;
dryer waste stacker to convey dust from the dryer dust collector to one of a waste pile and a screen infeed conveyor, the dryer dust collector including a stack, a knockout box, and a baghouse, wherein the stack pivots from a horizontal traveling position to a vertical operating position;
the screen infeed conveyor to convey dried sand from the dryer to the screen;
a screen waste conveyor to convey waste sand from the screen to a waste pile;
four silos to hold screened, each silo pivotable from a horizontal traveling position to a vertical operational position;
a silo in-feed conveyor to convey sand from the screen toward the at a silo feed lifter, which vertically raises the sand above the at least one silo; the silo feed lifter being one of a silo infeed telestacker and silo infeed elevator;
a first silo out-feed conveyor to convey sand from a first and second silo;
a second silo out-feed conveyor to convey sand from a third and fourth silo;
a truck loadout conveyor to receive sand from both the first and the second silo out-feed conveyors and to convey the sand toward a truck;
a plurality of pads placed underneath the wheels; and
a motor control center (MCC) to provide power and control signals to the various other wheeled operational units;
a temperature sensor located between an exit on the dryer and an entrance on the screen;
a two-way diverter located along a sand flow downstream from both the temperature sensor and the moisture meter and upstream from an the entrance to the screen, the two-way diverter able to divert sand away from the screen that measures a moisture over a set moisture limit or that measures a temperature over a set temperature limit;
a silo feed splitter to split feed from the silo in-feed elevator conveyor between the four silos; and
a pre-wired junction box installed on one or more of the non-MCC wheeled operational units, which the MCC plugs one or more cables directly into in order to provide one of power, control signals, and both power and control signals to the separate non-MCC wheeled operational units;
wherein the wheeled operational units are supported by at least two wheels while operating and further comprise a trailer hitch; and
wherein one or more of the wheeled operational units include an automatic height adjuster which, when activated, automatically elevates a portion of the wheeled operational unit from a traveling height to an operating height.
